(19) United States
(12) Patent Application Publication
(10) Pub. No.: US 2004/0046649 A1
(43) Pub. Date: Mar. 11, 2004

(54) Tire pressure monitoring system

(76) Inventors: Ramon A. Sanchez, Juarez (MX); Manuel S. Sanchez, Juarez (MX)

Correspondence Address: MARGARET A. DOBROWITSKY, DELPHI TECHNOLOGIES, INC., P.O. Box 5052, Mail Code: 480-410-202, Troy, MI, 48007-5052, US

(21) Appl. No.: 10/238,527

(22) Filed: Sep. 10, 2002

(51) Int. Cl. B60C 23/00

(52) U.S. Cl. 340/443

(57) ABSTRACT

A tire pressure monitoring system connectable to a valve stem for supplying air to a respective tire is provided. The system includes a pressure sensing device. A circuit board is configured to receive one or more circuit components associated with the pressure sensing device. A flex circuit is electrically coupled to the circuit board and the pressure sensing device to pass electrical signals between one another. A joining structure is provided for electromechanically connecting the circuit board to a respective valve stem end disposed within the tire. The valve stem may receive one electrical signal indicative of the level of pressure sensed by the pressure sensing device and may radiate the electrical signal to the surrounding environment. The foregoing embodiment may be adapted to applications that do not use any coupling to the valve stem and/or avoid use of any circuit board. In such an adaptation, the antenna may be configured in the flex circuit.

### BACKGROUND OF THE INVENTION

The present invention is generally related to sensing devices, and, more particularly, to tire pressure monitoring system and techniques for affixing and assembling such devices in the interior of a tire.

A pressure sensor is one important component of a direct tire pressure monitoring system (TPMS), such as may be prescribed by governmental regulations. See, for example, 49 CFR Part 571, Titled “Federal Motor Vehicle Safety Standards: Tire Pressure Monitoring Systems; Controls and Displays”. One basic configuration of a direct TPMS generally includes various components assembled within the interior of the tire. Most direct TPMSs are self-powered by a battery. In order to increase the protection of the TPMS's components from the typically corrosive environment inside a tire, such components may be encapsulated in a protective material, (one common protection is epoxy). Unfortunately, the application of the protective material may pose some difficulties. First, the protective material increases the mass of the sensor. This is undesirable because the sensor will be subjected to relatively high accelerations that could stress joining points and could result in reliability issues due, for example, to sensor separation from the tire rim. Second, the protective material may affect electrical connections among the different components and this could undermine the functional performance of the sensor and/or associated components, such as a transmitter. Third, the protective material may compromise tight geometric restrictions of the TPMS layout due to space limitations inside the tire rim. That is, there is a limited volume in which the sensor's components can be placed without risk of being damaged due to assembly or disassembly operations of the tire and tire rim. In view of the foregoing considerations, it would be desirable to provide configurations that may result in lowering the mass of the TPMS, increase reliability of the TPMS and facilitate its assembly/disassembly operations.

### BRIEF SUMMARY OF THE INVENTION

Generally, the present invention fulfills the foregoing needs by providing in one aspect thereof, a tire pressure monitoring system connectable to a valve stem for supplying air to a respective tire. The system includes a pressure sensing device. A circuit board is configured to receive at least one circuit component associated with the pressure sensing device. A flex circuit is electrically coupled to the circuit board and the pressure sensing device to pass electrical signals therebetween. A joining structure is provided for electromechanically connecting the circuit board to a respective valve stem end disposed within the tire. The valve stem may receive one electrical signal indicative of the level of pressure sensed by the pressure sensing device and may radiate the electrical signal to the surrounding environment.

The present invention further fulfils the foregoing needs by providing in another aspect thereof, a tire pressure monitoring system including a pressure sensing device and a power source. A flex circuit is electrically coupled to the pressure sensing device and to the power source to pass electrical signals therebetween and to components associated with the sensing device. One of the components may comprise a transmitter. An antenna is coupled to the transmitter to receive at least one electrical signal indicative of the level of pressure sensed by the pressure sensing device and radiate the electrical signal to the surrounding environment. The antenna may be configured within a first area of the flex circuit. A second area of the flex circuit is usable to receive the pressure sensing device and any associated components, wherein the flex circuit and any components thereon constitute an assemblage assembleable within a respective one of distinct housings. The respective one of the distinct housings is supportable by a rim where a corresponding tire is mounted, and is configured to meet a given rim configuration.

### BRIEF DESCRIPTION OF THE DRAWINGS

The features and advantages of the present invention will become apparent from the following detailed description of the invention when read with the accompanying drawings in which:

FIG. 1 illustrates an isometric view of a tire pressure monitoring system that may be connectable to a valve stem of a tire.

FIG. 2 illustrates a zoomed-in view of the tire pressure monitoring system of FIG. 1.

FIG. 3 illustrates an isometric view of the tire pressure monitoring system of FIG. 1 assembled within a respective housing.

FIG. 4 illustrates a schematic view of the system of FIG. 3 in relation to an exemplary rim that supports a tire.

FIG. 5 illustrates a tire pressure monitoring system construction wherein a circuit board extends generally along the longitudinal axis of the valve stem.

FIG. 6 illustrates an isometric view of another exemplary embodiment of a tire pressure monitoring system that may be used independent of any connection to the valve stem.

FIG. 7 illustrates an exploded view of an assemblage of the tire pressure monitoring system of FIG. 6 and a respective housing.

FIG. 8 illustrates the assemblage of FIG. 8 within its respective housing.

FIG. 9 illustrates a schematic view of the system of FIG. 8 in relation to an exemplary rim that supports a tire.

### DETAILED DESCRIPTION OF THE INVENTION

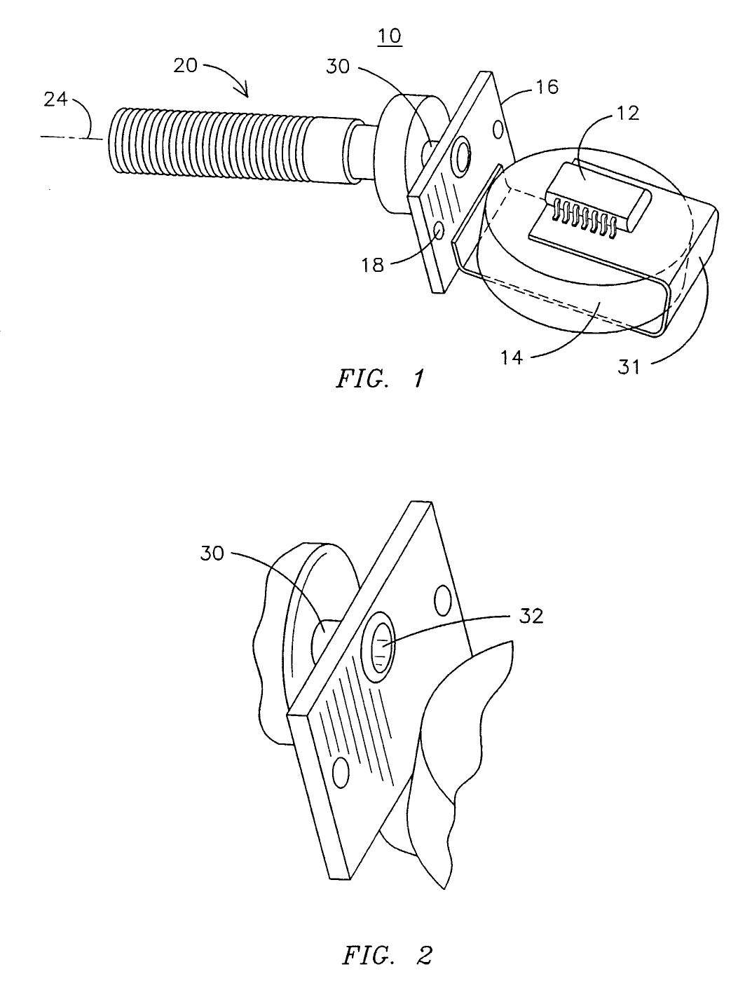

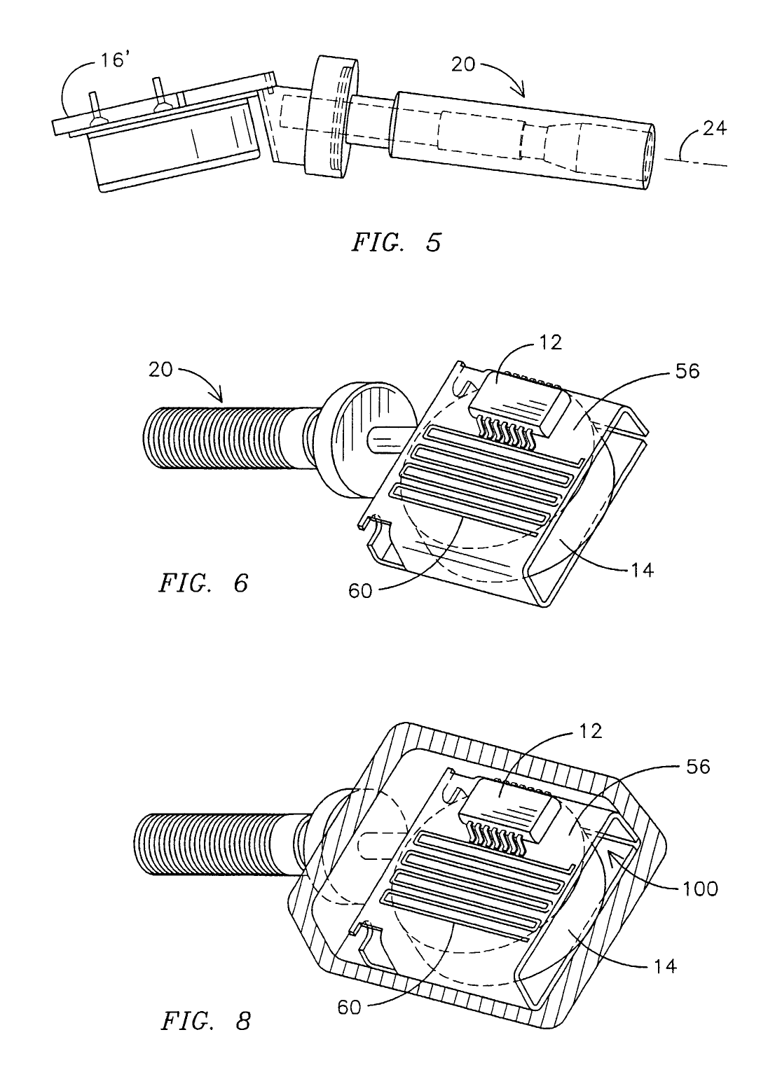

FIG. 1 illustrates one basic configuration of a direct tire pressure monitoring system (TPMS) 10, such as may be used in mobile assets that use pneumatically-inflatable tires. Examples of mobile assets may include cars, trucks, airplanes, industrial equipment, etc. The TPMS generally includes a pressure sensing device 12, a power source 14, e.g., a battery, an electronic circuit substrate, such as a printed circuit board (PCB) 16 and a transmitter 18. In one exemplary embodiment, PCB 16 may be made up of a relatively flat and hard board, which may include slots for integrated circuit chips and connections for a variety of electronic components. The PCB may be configured with electrically conductive pathways between the components. In one exemplary embodiment, PCB 16 may be joined to a respective valve stem 20 of the tire, and this would provide a reliable and low-cost attaching or affixing means to the tire rim. Such an embodiment may be used in applications that may require a direct electrical connection between the PCB and the metallic valve stem. One reason for providing this type of direct electrical connection is that the valve stem may function in some applications as the transmitter antenna of the TPMS. The geometrical relationship between the PCB and the valve stem may be better appreciated in FIGS. 1 through 3. More particularly, it will be appreciated that PCB 16 may be positioned generally perpendicular relative to the longitudinal axis 24 of valve stem 20. This geometric relationship between the PCB and the valve stem is believed to be advantageous for several reasons: 1) It simplifies the design of the valve stem by eliminating structural features that otherwise would be required to provide a surface of attachment between the valve stem and a board 16′ that extends generally along longitudinal axis 24. (This may be appreciated in the configuration shown in FIG. 5). 2) The orientation of the PCB shown in FIGS. 1 through 4 is conducive to saving space because standard components used in the TPMS, such as a micro controller and transmitter would be mounted on the board, for example, facing battery 14, and thus making use of space that otherwise would not be available to the designer. In this manner, the height of the board-mounted components would not necessarily result in an increase in the height of the footprint of the TPMS, as could occur when the board is set generally tangential relative to the rim's curvature (as the embodiment of FIG. 5).

As may be better appreciated in the zoomed-in view of FIG. 2, the connection between PCB 16 and the valve stem, by way of example and not of limitation, may comprise a joining structure, such as a press-fitted rivet-like soft metallic cylinder 30 inserted in an opening 32 through the PCB. Upon the end of the valve stem passing through the opening, the inner walls of the cylinder would be sufficiently deformable when pressed against the metallic stem to provide a reliable electromechanical connection between the PCB and the valve stem. The end of the cylinder may be configured to protect the connection from intrusion of any protective material. This direct connection between the PCB and the valve stem is conducive to increasing the efficiency of electromagnetic energy transfer from the RF transmitter to the surrounding environment and providing a direct path to the micro-controller that may be used for training of the sensor relative to tire position (front left, front right, etc.), or any calibration that may be needed. It will be appreciated that the present invention is not limited to the foregoing connection since many other types of structures for fastening the board to the valve stem will now be apparent to those skilled in the art. Examples of fastening structures may include a screw, a groove in the PCB configured to receive and provide a tight fit to the valve, a hook-like fastener, etc.

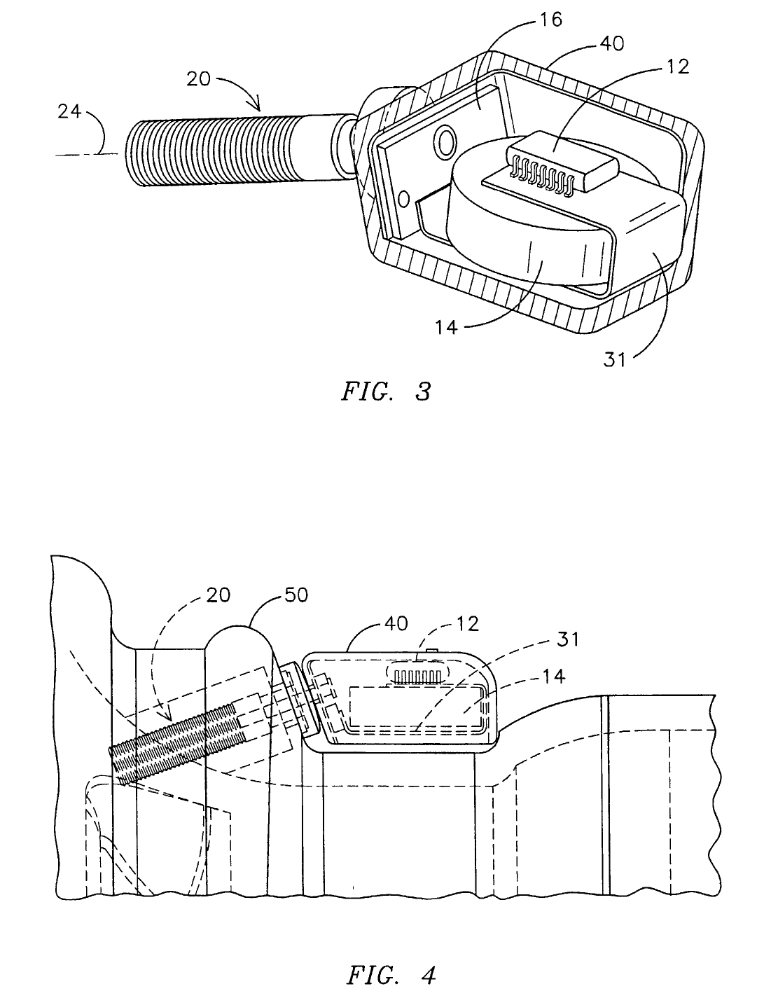

In another aspect of the present invention, as appreciated in FIGS. 1 through 4, a flexible circuit 31, such as may be made up of generally thin, flat and flexible conductor circuit elements and commonly referred to as “flex-circuit”, is provided for connecting sensing device 12 and battery 14 to the PCB. The inventors of the present invention have innovatively recognized that use of flex circuit 31 allows the designer to install the sensing device in any desired orientation and further allows to straightforwardly locate the battery within a housing 40, (FIG. 3) in the limited space allotted to the footprint of the TPMS relative to the geometry of the tire rim 50, as shown in FIG. 4.

In one exemplary embodiment, the desired orientation of the sensing device may be such that an air receiving porthole on the upper part of the sensor housing is disposed to face away from the rim of the tire. As will be appreciated by those skilled in the art, the sensing device may include not just a pressure sensing element since temperature sensing and/or acceleration sensing may be separately or integratedly provided. For example, the foregoing sensor orientation may cause any accelerometers therein to operate more efficiently, such as when the longitudinal axis of the porthole is perpendicular to the rim curvature. Proper accelerometer operation is desirable since this helps to decrease the power consumption of the TPMS by establishing certain periods, such as when the vehicle is stationary, in which the sensor would send a signal to an external receiver relative to the tire at a slower rate, as compared to when the vehicle is moving. The direct attachment of the circuit board to the valve stem is believed to ease the assembly operation of the TPMS because the need for soldering between these components is eliminated and the joining could be performed manually or with simple robotics equipment.

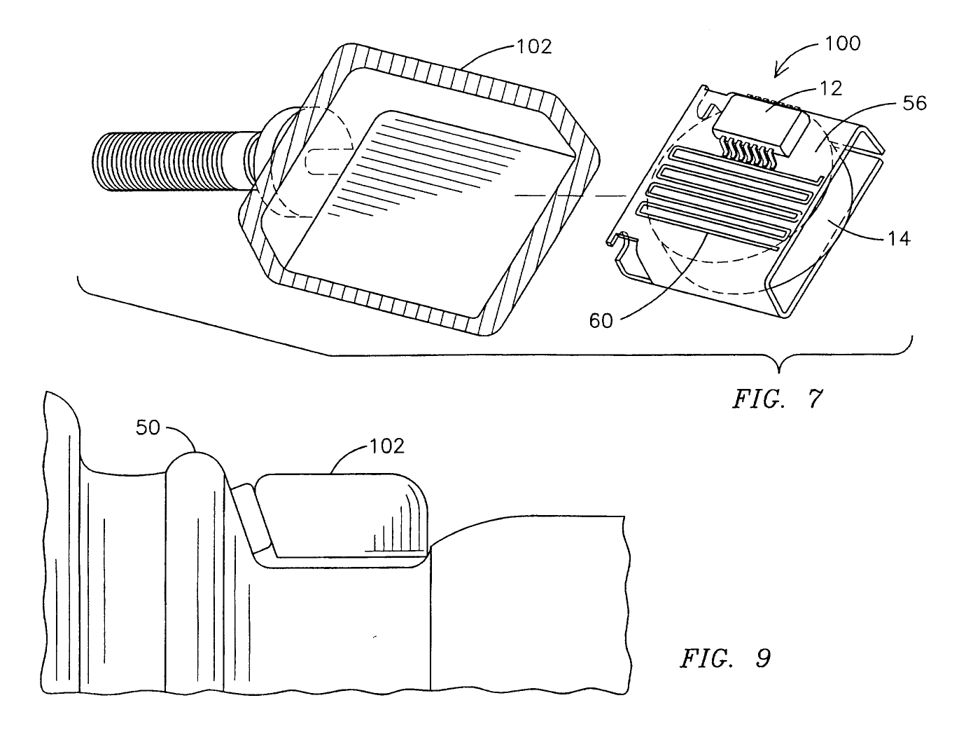

It will be appreciated that the present invention is not limited to embodiments that provide a direct connection between the PCB and the valve stem. For example, the embodiment illustrated in FIGS. 6-9 does not provide any direct connection to the valve stem. In fact, such embodiment eliminates the need of providing any PCB and uses a flex circuit 56 for interconnecting the TPMS's components. In one exemplary embodiment, flex circuit 56 is connected to the battery 14 and may be foldable about the battery. The sensing device 12 may be placed on the flex circuit along any desired orientation. In another aspect of the present invention, an antenna 60 may be integratedly configured within a portion of the flex circuit (e.g., a first area of the flex circuit). The rest of the components of the TPMS may be set on any remaining areas (e.g., a second area) of the circuit board (e.g., on the sides and underneath the battery), as shown on FIG. 6. As suggested above, inclusion of the antenna on the flex circuit eliminates the need of a connection with the valve, essentially making the TPMS an independent assemblage 100, as shown in FIG. 7. This assemblage may be placed in a respective one of distinct housing configurations (e.g., housing 102) that may be appropriately configured depending on the specific configuration of the corresponding rim. In this manner, the same assemblage may be used for different TPMS models that may be different just in their respective housing configuration.

FIG. 8 illustrates assemblage 100 subsequent to being assembled into exemplary housing 102 (FIGS. 7 and 8), that may be configured into the tire rim configuration illustrated in FIG. 9. It will be appreciated that the embodiment of FIGS. 6-9 need not be situated proximate to the valve stem since such embodiment does not require any direct coupling between the valve stem and the TPMS.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A tire pressure monitoring system connectable to a valve stem for supplying air to a respective tire, the system comprising:
a pressure sensing device;
a circuit board configured to receive at least one circuit component associated with the pressure sensing device;
a flex circuit electrically coupled to the circuit board and the pressure sensing device to pass electrical signals therebetween;
a joining structure for electromechanically connecting the circuit board to a respective valve stem end disposed within the tire, wherein the valve stem receives at least one electrical signal indicative of the level of pressure sensed by the pressure sensing device and radiates said electrical signal to the surrounding environment.

2. The tire pressure monitoring system of claim 1 wherein the at least one circuit component associated with the pressure sensing device comprises a transmitter and the valve stem constitutes an antenna for that transmitter.

3. The tire pressure monitoring system of claim 1 wherein the circuit board comprises a printed circuit board.

4. The tire pressure monitoring system of claim 1 wherein the circuit board is mounted generally perpendicular relative to the longitudinal axis of the stem valve, thus enabling a reduced footprint for any components thereon.

5. The tire pressure monitoring system of claim 1 wherein the joining structure comprises a metallic cylinder configured to pass through an opening in the circuit board.

6. The tire pressure monitoring system of claim 5 wherein the cylinder is sufficiently deformable upon being pressed to form a riveting structure between the valve stem and the circuit board.

7. The tire pressure monitoring system of claim 1 further comprising a power source and a housing configured to receive the power source, the pressure sensing device, the circuit board and the flex circuit.

8. A tire pressure monitoring system connectable to a valve stem for supplying air to a respective tire, the system comprising:
a pressure sensing device;
a circuit board configured to receive at least one circuit component associated with the pressure sensing device;
a flex circuit electrically coupled to the circuit board and the pressure sensing device to pass electrical signals therebetween; and
a joining structure for electromechanically connecting the circuit board to a respective valve stem end disposed within the tire, wherein the valve stem receives at least one electrical signal indicative of the level of pressure sensed by the pressure sensing device and radiates said electrical signal to the surrounding environment, with the circuit board mounted generally perpendicular relative to the longitudinal axis of the stem valve, thus enabling a reduced footprint for any components thereon.

9. A method for connecting a tire pressure monitoring system to a valve stem for supplying air to a respective tire, the method comprising:
providing a pressure sensing device;
configuring a circuit board to receive at least one circuit component associated with the pressure sensing device;
electrically coupling the circuit board and the pressure sensing device through a flex circuit to pass electrical signals therebetween; and
electromechanically connecting the circuit board to a respective valve stem end disposed within the tire, wherein the valve stem receives at least one electrical signal indicative of the level of pressure sensed by the pressure sensing device and radiates said electrical signal to the surrounding environment.

10. The method of claim 9 further comprising mounting the circuit board generally perpendicular relative to the longitudinal axis of the stem valve, thus enabling a reduced footprint for any components thereon.

11. The method of claim 9 wherein the connecting of the circuit board to the respective valve stem comprises providing a metallic cylinder configured to pass through an opening in the circuit board; and pressing the cylinder to form a riveting structure between the valve stem and the circuit board.

12. The method of claim 9 further comprising providing a power source, and configuring a housing to receive the power source, the pressure sensing device, the circuit board and the flex circuit.

13. A tire pressure monitoring system comprising:
a pressure sensing device;
a power source;
a flex circuit electrically coupled to the pressure sensing device and to the power source to pass electrical signals therebetween and to components associated with the sensing device, one of said components comprising a transmitter;
an antenna coupled to the transmitter to receive at least one electrical signal indicative of the level of pressure sensed by the pressure sensing device and radiate said electrical signal to the surrounding environment, the antenna configured within a first area of the flex circuit, with a second area of the flex circuit usable to receive the pressure sensing device and any other associated components, wherein the flex circuit and any components thereon constitute an assemblage assembleable within a respective one of distinct housings, the respective one of the distinct housings supportable by a rim where a corresponding tire is mounted, and configured to meet a given rim configuration.

14. A method for assembling a tire pressure monitoring system, the method comprising:
providing a pressure sensing device;
providing a power source;
electrically coupling the pressure sensing device to the power source through a flex circuit to pass electrical signals therebetween and to components associated with the sensing device, one of said components comprising a transmitter;
configuring an antenna within a first area of the flex circuit;
configuring a second area of the flex circuit to receive the pressure sensing device and any other associated components, wherein the flex circuit and any components thereon constitute an assemblage assembleable within a respective one of distinct housings, the respective one of the distinct housings supportable by a rim where a corresponding tire is mounted, and configured to meet a given rim configuration.
